(19) United States
(12) Patent Application Publication
(10) Pub. No.: US 2003/0041846 A1
(43) Pub. Date: Mar. 6, 2003

(54) Method and apparatus for electrical signal incorporated with ignition system

(76) Inventors: Tai-An Chiang, Taipei (TW); Arthur C. Wu, Foster City, CA (US)

Correspondence Address: ARTHUR C. WU, 969-G EDGEWATER BLVD #168, FOSTER CITY, CA, 94404, US

(21) Appl. No.: 09/888,300

(22) Filed: Jun. 22, 2001

(51) Int. Cl. F02P 1/00

(52) U.S. Cl. 123/619

(57) ABSTRACT

The invention presents a methodology and apparatus of incorporating electrical signal to ignition system of an internal combustion engine. The ignition system is equipped with a signal generator to generate oscillatory signal. The oscillatory signal can be amplitude modulated, frequency modulated, or pulse-width-modulated. The signal generator electrically connects with transformer. The transformer converts received signal into oscillatory high voltage, and further delivers oscillatory high voltage to igniter for ignition operation. The oscillatory voltage can excite fuel and reduce the fuel droplet size prior to ignition. The combustion process charged with oscillatory voltage can improve exhaust emission, and also can increase mechanical power output.

### FEDERALLY SPONSORED RESEARCH

Not Applicable

### SEQUENCE OF LISTING OR PROGRAM

Not Applicable

### TECHNICAL FIELD

The present invention relates to an ignition system for an internal combustion engine. More particularly, the present invention related to an electrical signal incorporated ignition system for an internal combustion engine.

### BACKGROUND OF INVENTION

The performance of an ignition system for a conventional internal combustion engine always is a challenge subject for engine manufacturers. An ignition system of a conventional internal combustion engine utilizes a storage battery to provide direct current voltage to a high voltage transformer. High voltage transformer sends high voltage power to an igniter and ignites premixed fuel and air in a combustion chamber. If there is a plurality of combustion chambers, the high voltage generated by the high voltage transformer is first sent to an electrical distributor before electrically connecting to various igniters. The burning of fuel air mixture produces power output and the exhaust fume is discharged after burning. The internal combustion engine starts a new cycle by taking in fresh fuel and air mixture for next cycle ignition. However, different types of fuels currently produced by fuel companies have different formulations and ingredients. The consistence of ignition varies considerably. In addition fuel properties may change slightly, leading to difficulties in ignition when the engine is in cold start. Poor fuel and air mixing can often cause partial burning of mixture in the combustion chambers and generates more soot and carbon monoxide. In brief, the ignition system of a conventional internal combustion engine generally shows the following deficiencies such as difficulty in ignition during cold start, and non-completed burning produced more soot particles and carbon monoxide. Toczyski et al. (U.S. Pat. No. 4,984,550) suggested to use an acoustic wave to send vaporized fuel into combustion chamber. However, the benefit is limited due to low frequency wave does not have enough energy to excite fuel molecules. Furthermore, when the intake fuel valve of combustion chamber is closed, the fuel and air mixture inside the combustion chamber cannot receive the benefit of acoustic wave anymore.

None of the other methods and apparatus has successfully optimized the atomized fuel and air mixing in the internal combustion chamber to provide efficient fuel burning. Special methods and apparatus have been proposed and constructed to deal with fuel efficiency associated with internal combustion, but no signal overall ignition methodology has been successful in dealing with ignition system. For this reason, there remains substantial room for improvement in the field.

### BRIEF DESCRIPTION OF THE INVENTION

Accordingly, it is an object of this invention to provide an improved ignition system, which can be efficiently, apply to different models of internal combustion engine. It is another object of preferred embodiment to provide an electrical ignition signal system, which can perform better clean burning of fuel and air mixture. It is further object of this present invention to provide an electrical ignition signal system to provide a range of frequency waves into the combustion chambers. It is another object of this present invention to provide an electrical ignition signal system to obtain better emission by reducing harmful emission in the exhaust. Harmful emission can be carbon monoxide, soot, NOₓ (where x is a number greater than 1), and the like. It is still another object of this present invention to provide an electrical ignition signal system to generate more power output based up the given fuel air ratio. It is further another object of this present invention to provide an electrical ignition signal system to reduce the solid carbon deposit on the wall of internal combustion chamber. It is yet another object of this present invention to provide an electrical ignition signal system to extend the usage of lubrication in the combustion chambers.

Briefly, this present invention is to provide an electrical signal incorporated ignition system for an internal combustion engine. The ignition system comprises a battery, an electrical signal generator, a high voltage generator, a fuel injector, an igniter and a combustion chamber. The battery provides a direct current voltage for the electrical signal generator and the high voltage transformer. The electrical signal generator, which is coupled with the battery, transforms the direct current voltage into an oscillatory voltage. The high voltage generator, which also is coupled to the battery, provides the need of high voltage for igniter. The fuel injector supplies fuel into the combustion chamber. The igniter is electrically connected to the high voltage generator and the signal generator. The igniter receives the oscillatory high voltage and further triggers an ignition in the combustion chamber of an internal combustion engine. The combustion engine may have a plurality of combustion chambers; the ignition system further comprises an electrical distributor, which is connected after the high voltage transformer. The electrical distributor connects electrically to the igniters where are located at each chamber. Correspondingly, the oscillatory voltage is sent to various igniters through the electrical distributor in sequence. Unlike a conventional ignition system ignited by a direct current voltage, an oscillatory voltage ignition can provide thoroughly burning result with clean exhaust fume.

An advantage of the present invention is that it utilizes a range of wave frequency to oscillate the fuel and air in the combustion chamber prior burning. This can provide better turbulent mixing in the combustion chamber. Another advantage of this present invention is that it can reduce the fuel particle size in order to achieve better turbulent diffusion. A further advantage of the present invention is that it can easily perform cold start for the internal combustion engine. Another advantage of the present invention is that it can have more completely burning and generates less amount of carbon monoxide. A still further advantage of the present invention is that it can reduce the solid carbon deposit on the wall of combustion chamber. Another advantage of this present invention is that it can increase power output based upon the provided fuel air mixing ratio.

These and other objects and advantages of the present invention will become clear to those skilled in the art upon review of the following specification, the accompanying drawings and the appended claims.

### BRIEF DESCRIPTION OF THE DRAWINGS

FIG. 1 is a schematic diagram showing an electrical signal incorporated ignition system for an internal combustion engine according to one embodiment of this invention;

FIG. 2 is a schematic diagram showing an electrical signal incorporated ignition system for an internal combustion engine according to alternative embodiment of this invention;

FIG. 3 is a schematic diagram showing an electrical signal incorporated ignition system for an internal combustion engine according to another embodiment of this invention;

FIG. 4 is a schematic diagram showing the internal component of en electric signal generator according to this invention.

### DESCRIPTION OF THE PREFERRED EMBODIMENTS

The present invention provides a method of incorporating an electrical signal to an ignition system of an internal combustion engine, comprising: providing an oscillatory device to generate an oscillatory signal, converting said oscillatory signal to an oscillatory voltage, igniting fuel with an igniting device; wherein said igniting device receives said oscillatory voltage.

The present invention also shows a method of providing electrical signal ignition system, comprising: converting a direct current voltage into an oscillatory voltage with an electrical signal generator device, transforming said oscillatory voltage into an oscillatory high voltage with a transformer device, igniting fuel in a combustion chamber with an igniter device, wherein said igniter device receives said oscillatory high voltage from said transformer device.

The present invention also provides a method of reducing the amount of carbon monoxide provided by an internal combustion device, comprising: providing an oscillatory voltage with a voltage generating device, igniting fuel with an igniting device, wherein said igniting device receives said oscillatory voltage; provided by the amount of carbon monoxide whereby said internal combustion device is less than an internal combustion device lacking said providing and said igniting.

The present invention also provides a method of increasing the power output provided by an internal combustion device, comprising: providing an oscillatory voltage with a voltage generating device, igniting fuel with an igniting device, wherein said igniting device receives said oscillatory voltage; provided by the amount of power output whereby said internal combustion device is more than an internal combustion device lacking said proving and said igniting.

The present invention also provides an apparatus capable of performing any of the abovementioned methods.

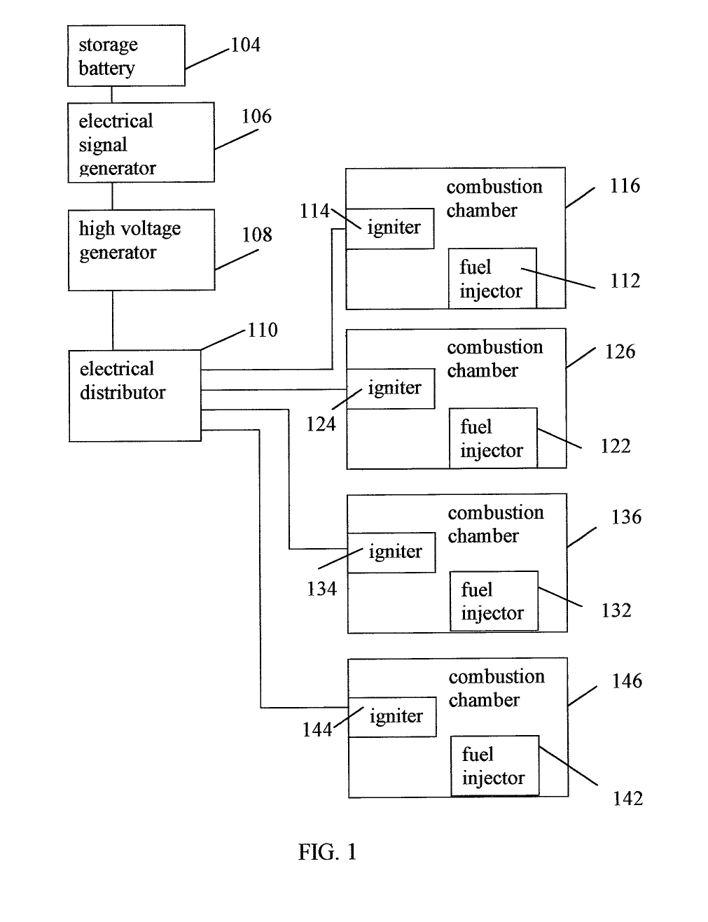

A preferred embodiment of an electrical ignition system for an internal combustion engine is illustrated in a schematic diagram in FIG. 1. The ignition system includes a storage battery 104, an electrical signal generator 106, a high voltage generator 108, an electrical distributor 110, four fuel injectors (112, 122, 132, 142), four igniters (114, 124, 134, 144) and four combustion chambers (116, 126, 136, 146). The storage battery 104 provides a direct current voltage to the electrical signal generator 106 and the electrical signal generator 106 produces oscillatory voltage. The high voltage generator 108 receives direct current power from the storage battery 104 and also receives oscillatory voltage from the electrical signal generator 106, and further transforms into oscillatory high voltage. The oscillatory high voltage can be over 2000 volts. The oscillatory high voltage is delivered to the electrical distributor 110, and is distributed to corresponding igniter of combustion chamber. The four fuel injectors (112, 122,132,142) supply fuel into the corresponding four combustion chambers (116, 126, 136, 146) in sequence. Each corresponding igniter is charged with oscillatory high voltage and triggers an ignition in its combustion chamber.

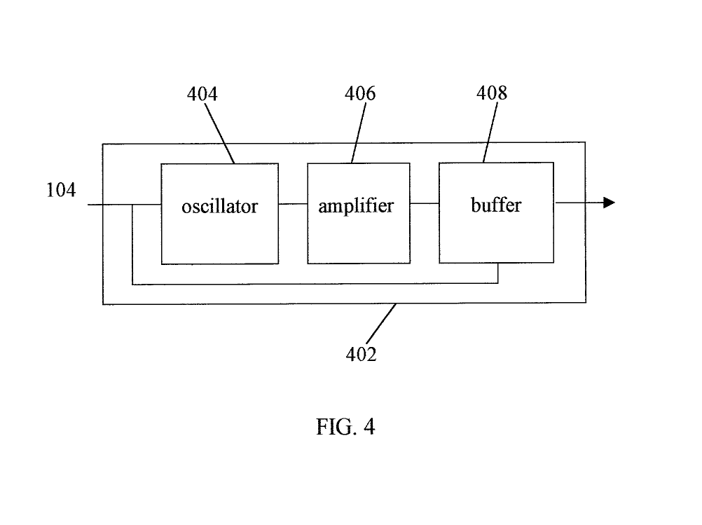

As shown in FIG. 4, the system of electrical signal generator 402 comprises an oscillator 404, an amplifier 406 and a buffer 408. The oscillator 404, which receives direct current electrical energy from the storage battery 104, generates an oscillating signal. The amplifier 406 is coupled to the oscillator 404 for enhancing the oscillatory signal. The buffer 408 is electrically coupled to the amplifier 406 and storage battery 104 for lowering overall loading of the system of electrical signal generator 402. The buffer 408 can be a device, which is doing impendence match to power amplifier or current amplifier function, or can be an isolator to separate power amplifier and current amplifier subsystems.

The oscillatory signal should have at least on full cycle or one pulse signal, when the oscillatory signal of the electrical signal generator 106 operates at a frequency range between 100 KHz and 18 GHz, and the preferred range of frequency is between 500 KHz and 10 GHz, the fuel in the combustion chamber receives an oscillatory effect; that is, molecules of fuel are energized, and fuel air thoroughly turbulent mixing. The fuel particle size is reduced due to the molecular excited vibration under the influence of oscillatory signal effect. When the corresponding igniter receives oscillatory high voltage, the oscillatory high voltage ignites the injected fuel inside the corresponding combustion chamber and produces clean burning. The wave type of oscillatory signal can be pulse type, analog type or the like. In addition, the oscillatory signal can be amplitude modulated (AM) or frequency modulated (FM) or pulse-width-modulated (PWM).

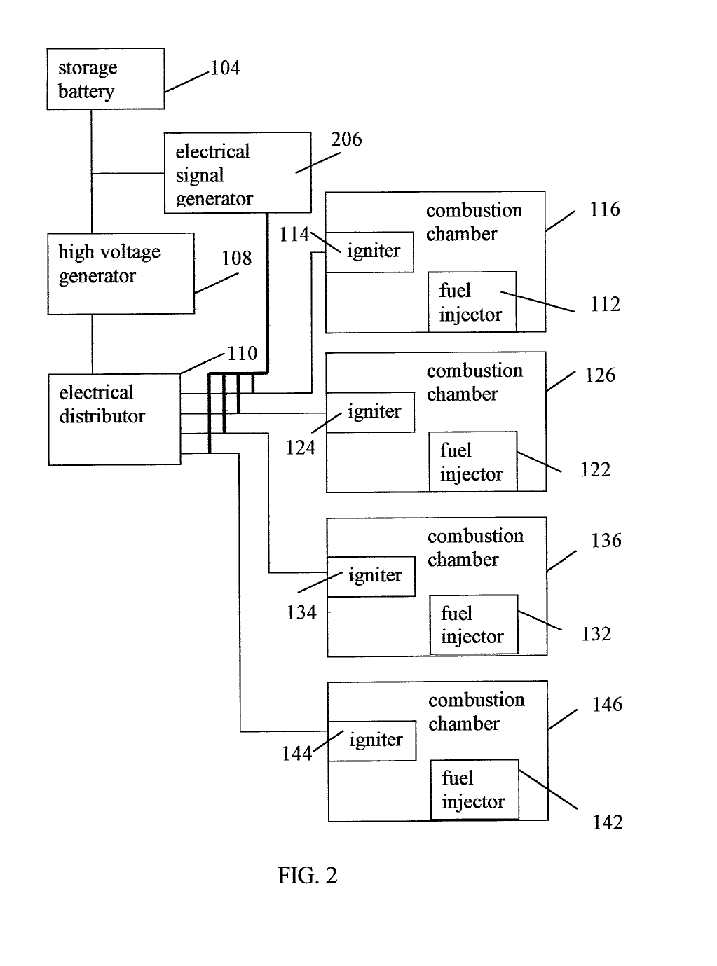

This invention also provides an alternative electrical signal ignition system as shown schematically in FIG. 2. The electrical signal ignition system showed in FIG. 2 comprises storage battery 104, high voltage generator 108, electrical distributor 110, four fuel injectors (112, 122, 132, 142), four igniters (114, 124, 134, 144), four combustion chambers (116, 126, 136, 146) and the electrical signal generator 206 which is electrically connected between storage battery 104, and four igniters (114, 124, 134, 144). The oscillatory voltage generated from the electrical signal generator 206 is constantly feeding into all four igniters (114, 124, 134, 144). When the electrical distributor 110 receives high voltage from high voltage generator 108 and distributes into corresponding igniter, the high voltage temporarily suppresses the direct oscillatory voltage from the electrical signal generator 206. In this alternative embodiment, each of four combustion chambers (116, 126, 136, 146) receives the duration of oscillatory mixing and cleaning from the direct oscillatory voltage. Fuel entering into and exhaust discharging from corresponding combustion chamber receives the beneficial effects of oscillatory voltage.

When the oscillatory signal of the electrical signal generator 206 operates at a frequency range between 100 KHz and 18 GHz, and preferred range of frequency is between 500 KHz and 10 GHz, the fuel in the combustion chamber receives an oscillatory effect. The fuel particle size is reduced due to molecular vibration and excitation, and fuel air thoroughly turbulent mixing. The wave type of oscillatory signal can be pulse type, analog type and the like. The oscillatory signal can be amplitude modulated (AM) or frequency modulated (FM) or pulse-width-modulated (PWM).

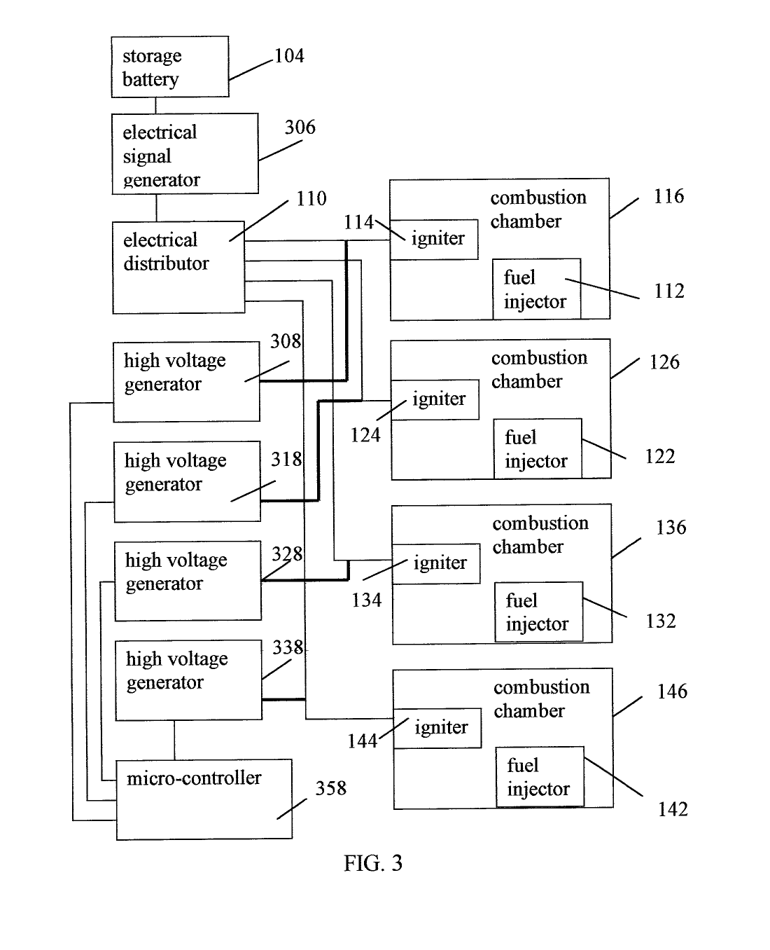

This invention also provides another electrical signal ignition system as shown schematically in FIG. 3. The electrical signal ignition system showed in FIG. 3 comprises storage battery 104, electrical distributor 110, four fuel injectors (112, 122, 132, 142), four igniters (114, 124, 134, 144), four combustion chambers (116, 126, 136, 146), electrical signal generator 306, and four high voltage generators (308, 318, 328, 338). Electrical signal generator 306 is electrically connected between storage battery 104 and electrical distributor 110. The four high voltage generators (308, 318, 328, 338) are controlled by a micro-controller 358 of engine computer and electrically connected to four igniters (114, 124, 134, 144) correspondingly. The oscillatory voltage generated from the electrical signal generator 306 is sent to electrical distributor 110 and is further delivered to four igniters (114, 124, 134, 144) in sequence. When fuel is injected into each combustion chamber (116,1126, 136, 146), the corresponding igniter (114, 124, 134, 144) receives oscillatory voltage from electrical distributor 110 and also receives high voltage from corresponding high voltage generator (308, 318, 328, 338) and ignites fuel air mixture and generates mechanical power output. The micro-controller 358 of engine computer synchronizes the control of each of high voltage generators (308, 318, 328, 338) and the electrical distributor 110, so both devices can deliver voltage to the corresponding igniter.

The oscillatory signal of the electrical signal generator 306 operates at a frequency range between 100 KHz and 18 GHz, and preferred range of frequency is between 500 KHz and 10 GHz, can make the fuel in the combustion chamber receive the beneficial oscillatory effects. The oscillatory signal generated from electrical signal generator 306 can be pulse type, analog type, or the like. The control mechanism can be amplitude modulated (AM) or frequency modulated (FM) or pulse-width-modulated (PWM). FIG. 1, FIG. 2, and FIG. 3 illustrate the setup of four combustion chambers, same methodology can apply to one, two, three, five, six, eight, twelve or other numbers of combustion chambers.

The electrical ignition signal system presented in this invention shows several benefits of improving internal combustion efficiency. When the fuel in the combustion chamber is energized and excited, the fuel droplet size is minimized. The fuel molecular vibration excited by oscillatory voltage can break up fuel droplet size and to allow fuel reaching atomized state. The smaller fuel droplet size in combustion chamber can make fuel and air fully mixing in a short period of time. When igniter charges into combustion chamber with oscillatory high voltage and ignites fuel air mixture. The fuel molecules can relatively easy locate oxygen and combine with oxygen to form the products of carbon dioxide and water vapor. Fuel can react and easy to reach the status of more complete burning based upon higher availability of oxygen in the nearby area, therefore the by products of carbon monoxide and soot formulation are greatly reduced. This is an attractive benefit for internal combustion engine for fuel lean burning. In convention internal combustion system air is pressurized to enter into combustion chamber. In order to reduce carbon monoxide in exhaust fume, extra mechanical work is needed to pressurize more air into combustion chamber in order to achieve fuel lean burning with less emission. The electrical ignition signal system presented in this invention can reduce the demand of air pressurization and still can reach high stage of complete burning. Thus the mechanical efficiency of internal combustion engine can be improved and the immediate benefit is to produce more power output. When combustion chamber consistently operates in efficient burning mode by the present invention, the environmentally polluted carbon monoxide is reduced, and other by products such as soot, NOₓ and solid carbon particles are also reduced. This higher combustion efficiency can save more fuel and still generate desirable mechanical output. When internal combustion engine can have better exhaust emission, this generally can extend the duration of oil lubrication in internal combustion system and also can extend the operation life time of internal combustion engine.

Those skilled in the art will readily recognize the numerous other modifications and alternations of the specific embodiment may be made without departing from the spirit and scope of the invention. Accordingly, the above disclosure is not to be considered as limiting and the appended claims are to be interpreted as encompassing the entire scope of the invention.

What is claimed is:

1. A method of incorporating an electrical signal to an ignition system of an internal combustion engine, comprising:
(a) providing an oscillatory device to generate an oscillatory signal,
(b) converting said oscillatory signal to an oscillatory voltage,
(c) igniting fuel with an igniting device; wherein said igniting device receives said oscillatory voltage.

2. The method according to claim 1, wherein said providing comprises:
(a) generating an oscillating signal with an oscillator,
(b) amplifying said oscillating signal with an amplifier, and
(c) reducing overall loading of said oscillatory device with a buffer.

3. The method according to claim 1, wherein said converting is performed by a transforming device.

4. The method according to claim 1, wherein the oscillatory signal is amplitude modulated.

5. The method according to claim 1, wherein the oscillatory signal is frequency modulated.

6. The method according to claim 1, wherein the oscillatory signal is pulse-width-modulated.

7. The method according to claim 1, wherein the oscillatory signal is a pulse signal.

8. The method according to claim 1, wherein the oscillator device has a frequency range between 100 KHz and 18 GHz.

9. An apparatus capable of incorporating an electrical signal to an ignition system according to the method of claim 1.

10. A method of providing an electrical signal ignition system, comprising:
(a) converting a direct current voltage into an oscillatory signal with an electrical signal generator device,
(b) transforming said oscillatory signal into an oscillatory high voltage with a transformer device,
(c) igniting fuel in a combustion chamber with an igniter device, wherein said igniter device receives said oscillatory high voltage from said transformer device.

11. An apparatus capable of performing an electrical signal ignition system according to the method according to claim 10.

12. The method according to claim 10, wherein the oscillatory signal is amplitude modulated.

13. The method according to claim 11, wherein the oscillatory signal is frequency modulated.

14. The method according to claim 10, wherein the oscillatory signal is pulse-width-modulated.

15. The method according to claim 10, wherein the oscillatory signal is a pulse signal.

16. The method according to claim 10, wherein the oscillating signal has a frequency range between 100 KHz and 18 GHz.

17. The method according to claim 10 further comprises:
(a) said oscillatory signal is generated by an oscillatory,
(b) said oscillatory signal is amplified by an amplifier,
(c) said electrical signal generator is buffered to reduce overall loading of said electrical signal generator.

18. A method of reducing the amount of carbon monoxide produced by an internal combustion device, comprising:
(a) providing an oscillatory voltage with a voltage transforming device;
(b) igniting fuel with an igniting device, wherein said igniting device receives said oscillatory voltage; produced by the amount of carbon monoxide whereby said internal combustion device is less than an internal combustion device lacking said providing and said igniting.

19. An apparatus capable of reducing the amount of carbon monoxide for the internal combustion device according to the method of claim 18.

20. A method of increasing the power output produced by an internal combustion device, comprising:
(a) providing an oscillatory voltage with a voltage transforming device;
(b) igniting fuel with an igniting device, wherein said igniting device receives said oscillatory voltage; provided by the amount of power output whereby said internal combustion device is more than an internal combustion device lacking said providing and said igniting.

21. An apparatus capable of increasing the power output for the internal combustion device according to the method of claim 20.
